(19) United States
(12) Patent Application Publication
(10) Pub. No.: US 2005/0081693 A1
(43) Pub. Date: Apr. 21, 2005

(54) Cutting machine

(75) Inventor: Takahisa Kashimoto, Yao-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: TEIPI THERMAL ENGINEERING CO., LTD., Hirakata-shi (JP); TEIKOKU PISTON RING CO., LTD., Tokyo (JP); SUMITOMO CHEMICAL COMPANY, LIMITED, Osaka (JP)

(21) Appl. No.: 10/949,248

(22) Filed: Sep. 27, 2004

(30) Foreign Application Priority Data
Oct. 15, 2003 (JP) 2003-354580

(51) Int. Cl. B26D 1/00

(52) U.S. Cl. 83/651

(57) ABSTRACT

A cutting machine 7 cuts an acrylic sheet 4 with brittle fracture by driving a cutting blade 11 into the acrylic sheet 4. The cutting blade 11 is installed below the acrylic sheet 4, an acrylic sheet pressing member 9 is installed above the acrylic sheet 4, the cutting blade 11 is fixed, and the acrylic sheet pressing member 9 is capable of moving up and down. In a different configuration of the invention, a member to support the acrylic sheet 4 may be installed and fixed and the cutting blade 11 may be moved up and down.

### BACKGROUND OF INVENTION

1. Field of Invention

The present invention relates to a cutting machine for cutting hard plastic sheet, and relates in particular to a cutting machine ideal for cutting hard plastic sheet such as thick acrylic sheet with a small percentage of rubber additive.

2. Description of Related Art

Cutting methods are known in the related art for driving cutting blades into both upper and lower surfaces of hard plastic sheet to create a brittle fracture point, and to make the brittle fracture spread along the direction of the sheet thickness. (See for example, Japanese Patent Non-Examined Publication No. 2001-047400, Japanese Patent Non-Examined Publication No. 2001-322096, and Japanese Patent Non-Examined Publication No. 2002-103293).

This cutting method includes the following features.

This method does not generate cutting waste which is impossible to recycle.

The cutting time is short.

The cutting machine and cutting die are inexpensive and a cut-out shape with highly accurate dimensions is obtained. The above method is therefore replacing conventional cutting methods, and becoming widely used for primary and secondary processing of all types of hard plastic sheet.

The current applicable operating range of this cutting method is as follows.

Material of the hard plastic sheet is acrylic plastic with a rubber additive content of less than 50%.

Thickness of the hard plastic sheet is 0.5 to 4 millimeters.

Shape of the cut may be a linear, or an enclosed shape such as circular or rectangular (punching).

On the other hand, hard plastic sheet with a rubber additive content of less than 20 percent and 4 or more millimeters thick is usually cut by a circular saw or belt saw. In this method, recycling of the cutting waste generated by the saw cutting is impossible. The cutting waste further tends to adhere to the hard plastic sheet due to static electrical charge properties so removing the cutting waste requires extra man-hours. The upper and lower surfaces of the hard plastic sheet are covered by a protective film. When the cutting sharpness of the saw deteriorates, the protective film peels off in sections near the cut surface. A strict inspection is therefore required because defects occur during secondary processing if the sheet is shipped with cutting waste still in the gap. A different cutting method is therefore needed that does not generate cutting waste.

However, when a conventional machine with cutting blades is used, the above method of driving cutting blades into the upper and lower surfaces of the sheet has the problem that in the case of thick hard plastic sheet such as acrylic sheet with 10 millimeters thick and the rubber content of 0 percent, steps and irregularities occur on the cut surface, the cut surface is rough and the cutting precision drops. In extreme cases, a sharp edge (burr) 34 sometimes appears where the cut surface meets the upper and lower surfaces of the sheet (see FIG. 9). This edge is extremely sharp and might damage other acrylic sheets, and so it is necessary to remove that edge manually. Therefore, it has been necessary to use conventional cutting machines with saws.

### DISCLOSURE OF INVENTION

After intensive investigation of the process for cutting thick hard plastic sheet, the inventors considered the following causes of steps, irregularities and unwanted edges.

The spreading of cracks through thick hard plastic sheet is basically unstable and preventing a number of irregularities from occurring on the crack surface is impossible. Therefore a cut surface with no steps (difference in level) can probably be achieved by making the crack spread from one side, rather than by trying to make the cracks join smoothly from both top and bottom.

Thick, hard plastic sheet contains some distortions and completely correcting these distortions during cutting is impossible. If the distortions are large, a time differential appears between when the tips of the upper and lower cutting blades cause cracks to occur. It tends to be difficult for the cracks to spread in surfaces where a compressive stress is applied. A mechanism acts to generate a curve in the crack and generate an edge when one crack by a cutting blade reaches the vicinity of the pressing-point of the other cutting blade during the period when the tip of the former cutting blade is making pressing contact with the hard plastic sheet.

Considering the above points, the present inventors realized that in the case of cutting thick hard plastic sheet, driving the cutting blade into one surface is more likely to yield a well cut surface. On the contrary, a related method has been used for cutting soft material such as rubber. In this method, a cutting blade is installed on just one side of the upper and lower surfaces of the material to be cut, a holder for the material is installed at a relative position, and the cutting blade is pressed into the material. In this cutting method, the cutting point moves along with the progress of the tip of the cutting blade. This is not brittle cutting. Cutting blade must be pressed in a distance greater than the material thickness. A knowledge of this method does not yield helpful hints about brittle cutting of hard plastic material.

In view of the problems with the related art, the present invention provides a cutting machine capable of obtaining a satisfactory cut surface that makes no steps, irregularities or burrs on the cut surface and generating no cutting waste when cutting thick hard plastic sheet. The present invention further provides a cutting machine capable of satisfactory cutting of thick hard plastic sheet when the sheet is covered by a protective film.

The present invention employs the following means to resolve the above mentioned problems. Namely, the present invention provides a cutting machine for brittle cutting by driving a cutting blade into a hard plastic sheet, wherein the cutting blade is installed either above or below on one side of the hard plastic sheet, a hard plastic sheet pressing member is installed on the other side of the hard plastic sheet, the cutting blade is fixed, and the hard plastic sheet pressing member is capable of moving up and down.

The cutting blade in the above structure is fixed. Fixing the cutting blade makes it highly stable during cutting. However, in the present invention, the cutting blade may also be movable up and down. The machine provided by the present invention may therefore also be structured as follows:

A cutting machine for brittle cutting by driving a cutting blade into a hard plastic sheet, wherein the cutting blade is installed either above or below on one side of the hard plastic sheet, and a hard plastic sheet supporting member is installed on the other side of the hard plastic sheet, the hard plastic sheet supporting member is fixed, and the cutting blade is capable of moving up and down.

In the cutting machine of the present invention, when the cutting blade is driven to a prescribed depth in the hard plastic sheet, a crack instantaneously spreads in the direction of the sheet thickness, and the hard plastic sheet is cut with brittle fracture. In this case, the cutting blade drive depth is preferably 0.4 to 0.8 millimeters. The cutting blade drive depth is more preferably 0.5 to 0.6 millimeters. This will yield both a long blade service life and good cutting surface quality.

The cutting machine of the present invention can satisfactorily cut a hard plastic sheet with a sheet thickness of 20 millimeters or less, preferably 4 to 20 millimeters, and more preferably 5 to 15 millimeters. The cutting machine of the present invention can also satisfactorily cut hard plastic sheet with a small percentage content of rubber or in other words, with a rubber content of 0 or below 20 percent by weight based on the sheet. The hard plastic sheet may be acrylic sheet, etc.

The time differential between when both ends of the tip of the cutting blade are driven in the width direction of the hard plastic sheet is preferably kept as small as possible to obtain a smooth and satisfactory cut surface. Therefore, the variation in the width direction of the vertical gap between the tip of the cutting blade and the hard plastic sheet pressing member or supporting member is preferably less than 0.2 millimeters and more preferably is less than 0.15 millimeters. Irregularities and roughness of the cut surface tends to increase in some cases if this variation is 0.2 millimeters or more.

Even when the hard plastic sheet is covered by a protective film, the cutting machine of the present invention cuts the protective film as well as the plastic sheet, which are placed on the hard plastic sheet pressing member or supporting member side at the exact same position as the hard plastic sheet with no peeling in such a manner that the protective film is placed on the opposite surface to the surface facing the cutting blade, of the plastic sheet. This effect is achieved due to factors such that there is little elongation of the protective film, there is some adhesive force acting on the hard plastic sheet, and the edge where the hard plastic sheet is cut is sharp, etc.

The cutting blade is preferably a Thomson blade. The cutting blade tip may be a linear shape or an enclosed shape on a flat surface.

The cutting machine of the present invention cuts the hard plastic sheet with brittle fracture so no cutting waste is generated, cutting time is short and cutting precision is high. A satisfactory cut surface is obtained without steps, irregularities or burrs, even when cutting thick hard plastic sheet with little rubber content. The cutting is also satisfactory even when the hard plastic sheet is thick and covered by a protective film.

### BRIEF DESCRIPTION OF DRAWINGS

FIG. 1 is a frontal view of one embodiment of the present invention;

FIG. 2 is a perspective view showing the acrylic sheet pressing member;

FIG. 3 is a cross sectional view taken along lines A-A in FIG. 2;

FIG. 4 is a perspective view showing the blade cartridge;

FIG. 5 is a cross sectional view taken along lines A-A in FIG. 4;

FIG. 6 is a cross sectional view taken along lines B-B in FIG. 4;

FIG. 7 is a frontal cross sectional view showing the upper bed portion of the cutting machine;

FIG. 8 is a frontal cross sectional view showing the lower bed portion of the cutting machine;

FIG. 9 is a drawing showing the edge formed on the cut surface.

### DESCRIPTION OF PREFERRED EMBODIMENTS

The preferred embodiments of the present invention are described next while referring to the accompanying drawings. The present embodiment applies the present invention to a cutting machine for cutting a continuous acrylic sheet at a determined size.

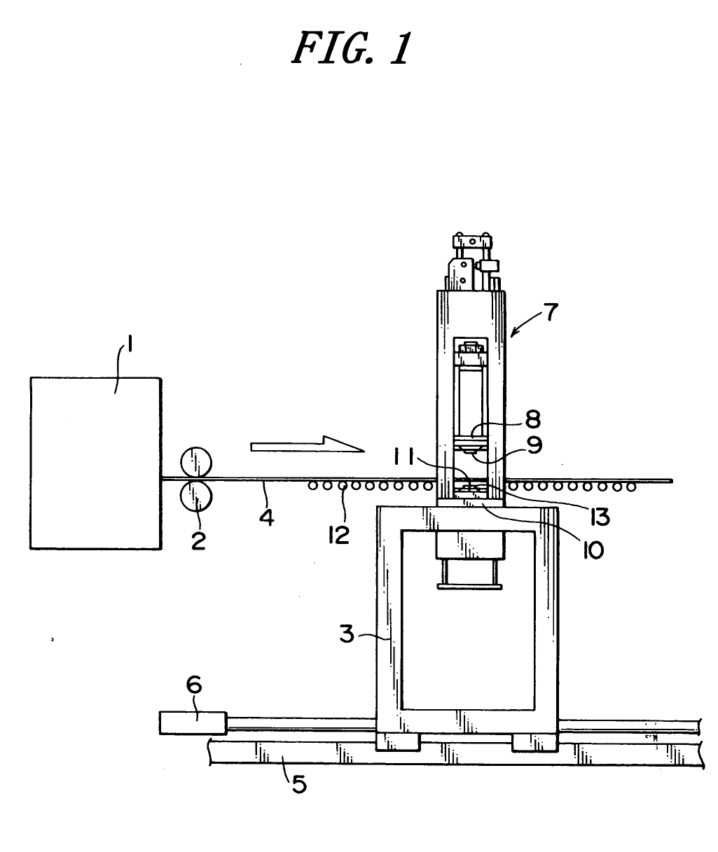

In FIG. 1, an extrusion machine 1, a drive roller 2, and a synchronous cart 3 are arranged from left to right.

The extrusion machine 1 continually extrudes an acrylic sheet 4 at a fixed speed. The extrusion machine 1 for example continually extrudes the 10 millimeter thick, 1,500 millimeter wide acrylic sheet 4 with rubber content of 0 percent, at a speed of 1 meter per minute. The synchronous cart 3 is mounted on a pair of rails 5 in parallel with the direction of the movement of the acrylic sheet 4. The synchronous cart 3 is first located at the initial position on the left side and is capable of moving to the right and to the left and returning to the initial position by a cart drive device 6. The drive roller 2 contains a rotary encoder for detecting the number of roller rotations. The cart drive device 6 is regulated by a control means to drive the synchronous cart 3 in synchronization with the movement of the cutting position of the acrylic sheet 4 by a signal from the rotary encoder.

A cutting machine 7 is mounted in the upper part of the synchronous cart 3. The cutting machine 7 is comprised of an acrylic sheet pressing member 9 for applying a pressing force to the acrylic sheet 4 and being provided on a vertically movable upper bed 8 side, and a cutting blade 11 provided on a fixed lower bed 10 side. The acrylic sheet pressing member 9 and the cutting blade 11 are arranged at relative positions above and below the acrylic sheet 4. The cutting blade 11 is a belt-shaped Thomson blade extending linearly in the width direction of the acrylic sheet 4. The lengths of the acrylic sheet pressing member 9 and the cutting blade 11 are longer than the width of the acrylic sheet 4.

The main specifications of the cutting machine 7 are as follows.
Pressurizing force: 300 kilonewtons
Stroke: 20 millimeters (during continuous operation)
Daylight: 194 millimeters
No load descent speed: 26 millimeters per second
Driving speed: 10 millimeter per second.

Support rollers 12 that support the acrylic sheet 4 are at positions before and behind the cutting machine 7. The height of the support roller 12 is set to a height where the acrylic sheet 4 does not make contact with the acrylic sheet pressing member 9, and a resilient piece 16 of a blade cartridge 13 described later.

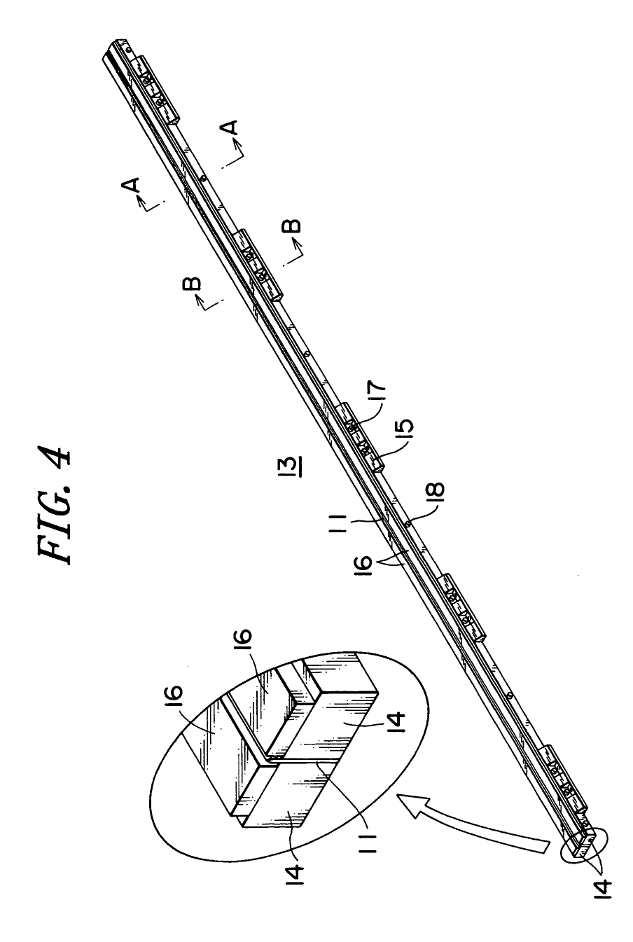

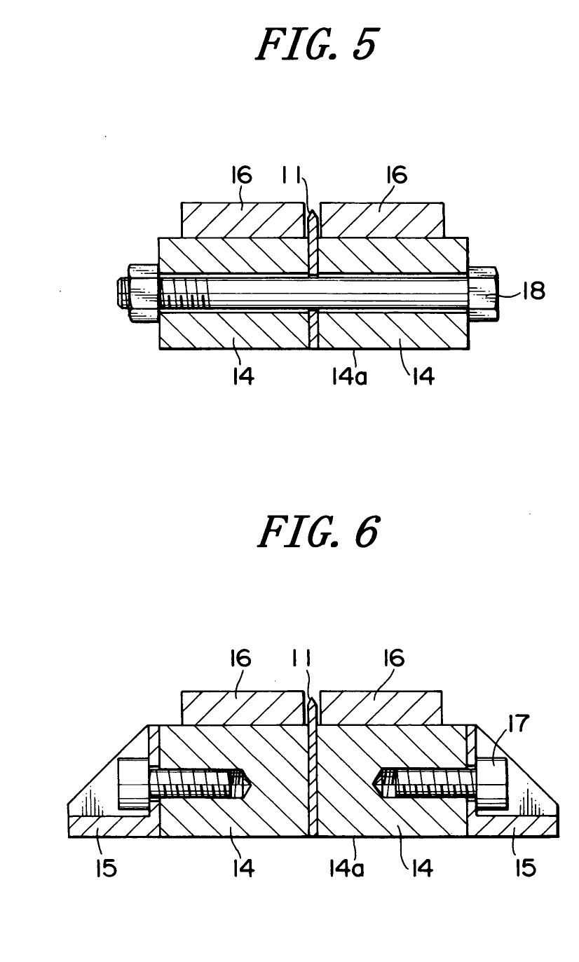

The blade cartridge 13 is described next while referring to FIG. 4, FIG. 5, FIG. 6, and FIG. 8. As shown in FIG. 4, FIG. 5, and FIG. 6, the blade cartridge 13 is comprised of a pair of holding blocks 14 arranged adjacent to each other, and multiple clamping taper blocks 15 secured to the respective outer sides of the pair of holding blocks 14, and the cutting blade 11 made up of one belt-shaped Thomson blade fixed between the inner surfaces of the pair of holding blocks 14, and the pair of resilient pieces 16 installed on both sides of the cutting blade 11.

Each of the holding blocks 14 is made up of square rod of aluminum alloy in a rectangular shape and having a width longer than the acrylic sheet 4. The clamping taper blocks 15 are blocks with a cross section roughly in the shape of a right triangle, and secured by bolts 17 at five equally spaced locations longitudinally on the holding block 14. The cutting blade 11 is secured between the pair of holding blocks 14 by a bolt-nut means 18. The tip of the cutting blade 11 protrudes from one surface of the holding block 14. The length of the cutting blade 11 is longer than the width of the acrylic sheet 4. The resilient piece 16 is made of narrow sponge of rubber with a rectangular cross section. The resilient piece 16 is arranged on both sides of the tip of the cutting blade 11 and bonded to the surface of the holding block 14. The resilient piece 16 is slightly thicker than the height that the cutting blade 11 protrudes from the holding block 14. The tip of the cutting blade 11 does not protrude from the resilient piece 16, when pressure is not applied to the resilient piece 16, in order to prevent cutting hands or fingers.

The surface on the opposite side to the tip of the cutting blade 11 in the pair of holding blocks 14 of the blade cartridge 13, forms a reference surface 14a. Taper surfaces 15a of the pair of clamping taper blocks 15 are formed to widen towards the reference surface 14a.

The blade cartridge 13 is set in the cutting machine 7 as shown in FIG. 8.

As shown in FIG. 8, reference taper blocks 19 are secured at five equally spaced locations perpendicular to the flow direction of the acrylic sheet 4, on the upper surface forming the reference surface of a lower substrate 20 secured to the lower bed 10 of the cutting machine 7. A clamping taper block 21 is installed at a relative position to the reference taper block 19, on the upper surface forming the reference surface of the lower substrate 20. The clamping taper block 21 is installed for front and rear movement along the upper surface forming the reference surface of the lower substrate 20, on a cross sectional L-shaped member 23 clamped by a bolt-nut means 22 on the lower substrate 20. The clamping taper block 21 is capable of advancing or retreating relative to the reference taper block 19 by means of an air cylinder not shown in the drawing. The reference taper block 19 and the clamping taper block 21 contain taper surfaces 19a, 21a on their respective relative surfaces. Both of these taper surfaces 19a, 21a are formed to widen towards the upper surface of the lower substrate 20.

As shown in FIG. 8, when the blade cartridge 13 is set in the cutting machine 7, the blade cartridge 13 is inserted longitudinally into the space of the cross sectional trapezoid enclosed by the lower substrate 20 clamped to the lower bed 10, the reference taper block 19 and the clamping taper block 21, and when the clamping taper block 21 is pressed to the reference taper block 19 side by the air cylinder, the reference surface 14a is pressed to the upper surface formed by the reference surface of the lower substrate 20, along with the taper surface 15a of the clamping taper block 15 being pressed to the taper surface 19a of the reference taper block 19 so the blade cartridge 13 is accurately positioned and clamped.

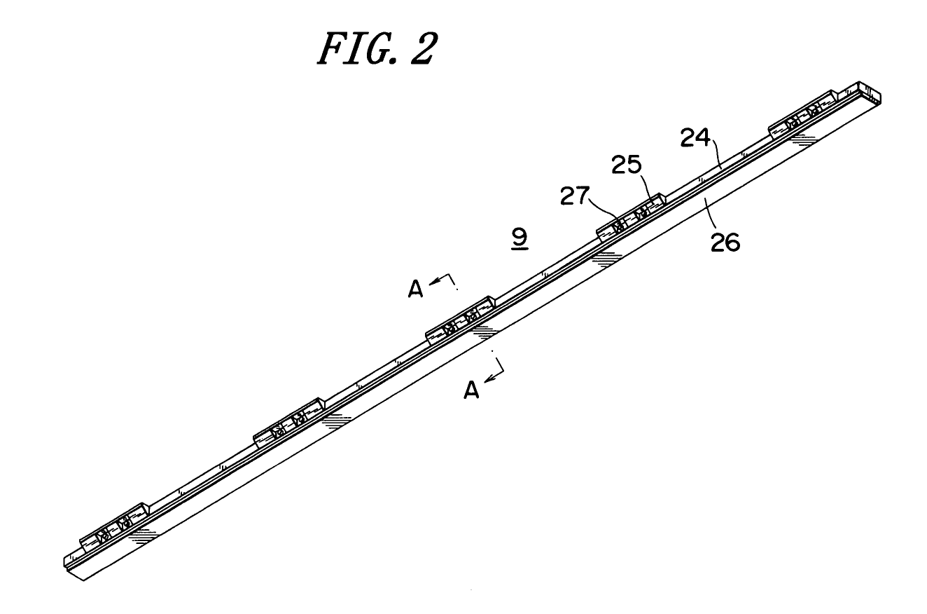

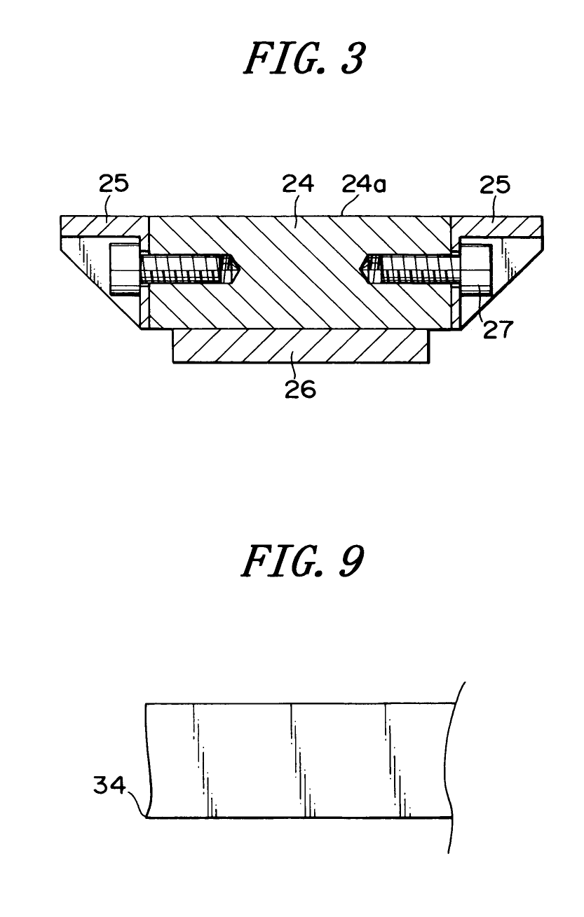

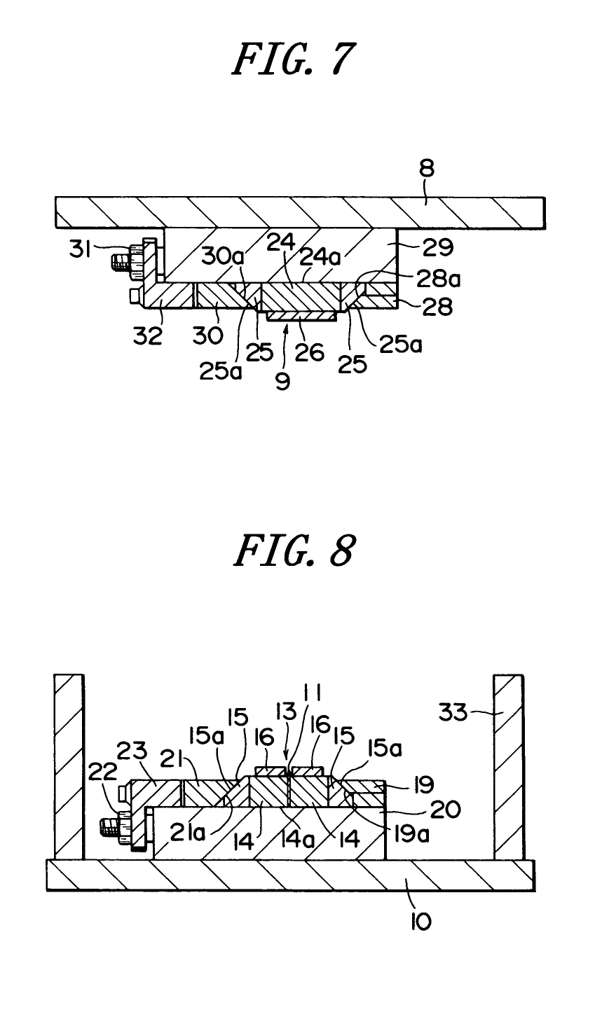

The acrylic sheet pressing member 9 is described next while referring to FIG. 2, FIG. 3 and FIG. 7. As shown in FIG. 2 and FIG. 3, the acrylic sheet pressing member 9 is made up of a holding block 24, and multiple clamping taper blocks 25 clamped to both outer side surfaces of the holding block 24, and a pressing plate 26 clamped to the bottom side of the holding block 24.

The holding block 24 is a square rod of aluminum alloy in a rectangular shape and having a width longer than the acrylic sheet 4. The clamping taper blocks 25 are blocks with a cross section roughly in the shape of a right triangle, and secured by bolts 27 at five equally spaced locations longitudinally on the holding block 24. The pressing plate 26 is made of hard plastic such as acrylic plastic. The pressing plate 26 is longer than the width of the acrylic sheet 4.

The surface on the opposite side to the pressing plate 26 in the holding block 24 of the acrylic sheet pressing member 9 forms a reference surface 24a. Taper surfaces 25a of the pair of clamping taper blocks 25 are formed to widen towards the reference surface 24a.

As shown in FIG. 7, the acrylic sheet pressing member 9 is set in the cutting machine 7.

In FIG. 7, reference taper blocks 28 are secured at five equally spaced locations perpendicular to the flow direction of the acrylic sheet 4, on the lower surface forming the reference surface of an upper substrate 29 secured to the upper bed 8 of the cutting machine 7. A clamping taper block 30 is installed at a relative position to the reference taper block 28, on the lower surface forming the reference surface of the upper substrate 29. The clamping taper block 30 is installed for front and rear movement along the lower surface forming the reference surface of the upper substrate 29, on a cross sectional L-shaped member 32 clamped by a bolt-nut means 31 on the upper substrate 29. The clamping taper block 30 is capable of advancing or retreating relative to the reference taper block 28 by means of an air cylinder not shown in the drawing. The reference taper block 28 and the clamping taper block 30 contain taper surfaces 28a, 30a on their respective relative surfaces. Both of these taper surfaces 28a, 30a are formed to widen towards the lower surface of the upper substrate 29.

As shown in FIG. 7, when the acrylic sheet pressing member 9 is set in the cutting machine 7, the acrylic sheet pressing member 9 is inserted longitudinally into the space of the cross sectional trapezoid enclosed by the upper substrate 29 clamped to the upper bed 8, the reference taper block 28 and the clamping taper block 30. When the clamping taper block 30 is pressed to the reference taper block 28 side by the air cylinder, the reference surface 24a is pressed to the lower surface formed by the reference surface of the upper substrate 29, along with the taper surface 25a of the clamping taper block 25 being pressed to the taper surface 28a of the reference taper block 28. Therefore, the acrylic sheet pressing member 9 is in this way accurately positioned and clamped.

A stopper 33 installed between the upper bed 8 and the lower bed 10 controls the drive depth of the cutting blade 11 into the acrylic sheet 4. The block-shaped stopper 33 is formed upright on the upper surface of the lower bed. The height of the stopper 33 is formed so that the drive depth of the cutting blade 11 into the acrylic sheet 4 is 0.4 to 0.8 millimeters (more preferably 0.5 to 0.6 millimeters) during cutting when the upper bed 8 lowers and contacts the upper surface of the stopper 33. Incidentally, the cutting blade drive depth of the conventional art driving cutting blades into both upper and lower surfaces of the hard plastic sheet is 0.05 to 0.4 millimeters for both the upper and lower surfaces.

The time differential between when both ends of the tip of the cutting blade 11 are driven in the width direction of the acrylic sheet 4 is preferably kept as small as possible to obtain a smooth and satisfactory cut surface. The variation in the width direction of the vertical gap between the tip of the cutting blade 11 and the acrylic sheet pressing member 9 is less than 0.2 millimeters and preferably is less than 0.15 millimeters.

The operation of the cutting machine 7 is described next.

The extrusion machine 1 continually extrudes the acrylic sheet 4 outward, and the acrylic sheet 4 flows rearward at a specific speed while mounted on the drive roller 2 and the support roller 12. When the cutting position for the acrylic sheet 4 reaches the cutting blade 11 of the cutting machine 7, the cart drive device 6 is regulated by a control means to drive the synchronous cart 3 by a signal from the rotary encoder built into the drive roller 2, so that the synchronous cart 3 starts to move rearward in synchronization with the speed of the acrylic sheet 4.

Next, the acrylic sheet pressing member 9 lowers toward the acrylic sheet 4 by the lowering of the upper bed 8 on the cutting machine 7, and contacts the upper surface of the acrylic sheet 4. Further, when the acrylic sheet pressing member 9 lowers, the acrylic sheet 4 is pressed downwards, and contacts the cutting blade 11. Also, when the acrylic sheet pressing member 9 lowers, and the cutting blade 11 is driven to a specified depth into the acrylic sheet 4, a crack instantaneously spreads in the direction of the sheet thickness and the acrylic sheet 4 is cut with brittle fracture.

Though not shown in FIG. 1, a protective film covering device might sometimes be installed between the extrusion machine 1 and the drive roller 2 to protect the upper and lower surfaces of the acrylic sheet 4. Even when the upper and lower surfaces of the acrylic sheet 4 are covered with protective films by this protective film covering device, the protective film facing the acrylic sheet pressing member 9 side can be cut at exactly the same position as the acrylic sheet 4 and no peeling occurs. This is due to the fact that there is little elongation of the protective film, there is some adhesive force acting on the acrylic sheet 4, and the edge where the acrylic sheet 4 is cut is sharp, etc.

The cutting blade 11 can be replaced during continuous extrusion machine operation. The blade can be replaced with an extremely high degree of safety and can also be replaced within a short time if using the blade cartridge 13. The cutting blade can therefore be replaced without stopping the production line.

The effect of the cutting machine of the present invention as verified by testing is described next. Two types of cutting machines and four types of acrylic sheet were utilized in the test. The test evaluated the quality of the cut surface by roughness or burrs on the cut surface. The cutting machine A was a cutting machine of the present invention as described in the above embodiment, for driving the cutting blade from one side of the sheet. The cutting machine B was a cutting machine of the prior art for driving the cutting blade from both the upper and lower sides of the sheet. The drive depth was 0.5 millimeters on the cutting machine A, and was 0.2 millimeters on both the upper and lower sides on the cutting machine B. The test results are shown in Table 1.

TABLE 1

| Rubber | | Sheet | Sheet |
|---|---|---|---|
| Content | Cutting | Thickness | Thickness |
| (%) | Machine | 3 mm | 10 mm |
| 0% | A | Δ | Δ |
| 0% | B | ◯ | X (edge present) |
| 30% | A | ◯ | Δ |
| 30% | B | ◯ | X (rough) |

Note:
The symbols ◯, Δ and X respectively indicate excellent, good, and poor in the quality of the cut surface.

Results in Table 1 show that the cutting machine A of the present invention exerts fewer influences of the sheet thickness on the quality of the cut surface compared to the cutting machine B of the prior art. Table 1 further shows that the cutting machine A of the present invention can satisfactorily cut an acrylic sheet with a thickness of 10 millimeters, while the cutting machine B of the prior art can not.

Besides the linear cutting described in the above embodiment, the cutting machine of the present invention can also be utilized for cutting (punching) before or after the secondary processing of the hard plastic sheet.

1. A cutting machine for brittle cutting by driving a cutting blade into a hard plastic sheet, wherein said cutting blade is installed either above or below on one side of said hard plastic sheet, a hard plastic sheet pressing member is installed on the other side of said hard plastic sheet, said cutting blade is fixed, and said hard plastic sheet pressing member is capable of moving up and down.

2. A cutting machine for brittle cutting by driving a cutting blade into a hard plastic sheet, wherein said cutting blade is installed either above or below on one side of said hard plastic sheet, and a hard plastic sheet supporting member is installed on the other side of said hard plastic sheet, said hard plastic sheet supporting member is fixed, and said cutting blade is capable of moving up and down.

3. A cutting machine as claimed in claim 1, wherein the drive depth of said cutting blade is 0.4 to 0.8 millimeters.

4. A cutting machine as claimed in claim 2, wherein the drive depth of said cutting blade is 0.4 to 0.8 millimeters.

5. A cutting machine as claimed in claim 1, wherein the thickness of said hard plastic sheet is 4 to 20 millimeters.

6. A cutting machine as claimed in claim 2, wherein the thickness of said hard plastic sheet is 4 to 20 millimeters.

7. A cutting machine as claimed in claim 5, wherein the rubber additive content of said hard plastic sheet is 0 or is less than 20 percent by weight based on the sheet.

8. A cutting machine as claimed in claim 6, wherein the rubber additive content of said hard plastic sheet is 0 or is less than 20 percent by weight based on the sheet.

9. A cutting machine as claimed in claim 7, wherein said hard plastic sheet is acrylic sheet.

10. A cutting machine as claimed in claim 8, wherein said hard plastic sheet is acrylic sheet.

11. A cutting machine as claimed in claim 1, wherein the variation in the width direction of the gap between the tip of said cutting blade and said hard plastic sheet pressing member or supporting member is less than 0.2 millimeters.

12. A cutting machine as claimed in claim 2, wherein the variation in the width direction of the gap between the tip of said cutting blade and said hard plastic sheet pressing member or supporting member is less than 0.2 millimeters.

13. A cutting machine as claimed in claim 1, wherein there is a protective film on the opposite surface to the surface facing said cutting blade, of said hard plastic sheet.

14. A cutting machine as claimed in claim 2, wherein there is a protective film on the opposite surface to the surface facing said cutting blade, of said hard plastic sheet.

15. A cutting machine as claimed in claim 1, wherein said cutting blade is a Thomson blade.

16. A cutting machine as claimed in claim 2, wherein said cutting blade is a Thomson blade.

17. A cutting machine as claimed in claim 1, wherein said cutting blade tip has a linear shape.

18. A cutting machine as claimed in claim 2, wherein said cutting blade tip has a linear shape.

19. A cutting machine as claimed in claim 1, wherein said cutting blade tip has an enclosed shape on a flat surface.

20. A cutting machine as claimed in claim 2, wherein said cutting blade tip has an enclosed shape on a flat surface.
